(19) United States
(12) Patent Application Publication
(10) Pub. No.: US 2007/0274310 A1
(43) Pub. Date: Nov. 29, 2007

(54) METHOD AND SYSTEM FOR PROCESSING ABNORMALLY BECOMING POWER OFF OF A TERMINAL OF MULTICAST USER

(76) Inventors: Jiahong WEI, Shenzhen (CN); Jun LI, Shenzhen (CN); Jun ZHANG, Shenzhen (CN)

Correspondence Address: LADAS & PARRY LLP, 224 SOUTH MICHIGAN AVENUE, SUITE 1600, CHICAGO, IL, 60604, US

(21) Appl. No.: 11/679,393

(22) Filed: Feb. 27, 2007

(30) Foreign Application Priority Data
May 29, 2006 (CN) 200610060903.4

(51) Int. Cl. H04L 12/56

(52) U.S. Cl. 370/390; 370/401

(57) ABSTRACT

A method and a system for processing abnormally becoming power off of a multicast user terminal are disclosed, and the method includes: a multicast device deletes multicast group(s) corresponding to the multicast user terminal and not watched by any multicast user terminal, upon receipt of a notification from the multicast user terminal for exiting all multicast groups when the multicast user terminal becomes powered off and started up again. Embodiments of the present invention can save bandwidth of a line effectively, and enable bandwidths of other services to be guaranteed better.

### FIELD OF THE TECHNOLOGY

The present invention relates to data transmission technologies, and more particularly, to multicast processing technologies.

### BACKGROUND OF THE INVENTION

Multicast is a network technology allowing one or more senders (multicast source) to send a single data packet to multiple receivers once.

To implement an Internet Protocol (IP) multicast transmission, a multicast source, multicast receivers and a low layer network between them must support the multicast. The multicast source sends a data packet to a specific multicast group and then all the receivers whose addresses belong to the specific multicast group can receive the data packet. A host (a user terminal) joins a multicast group using Internet Group Management Protocol (IGMP). Furthermore, the host can leave a multicast group dynamically, that is to say, the state of a member of a multicast group can be changed at any moment.

When joining in a multicast group, a host notifies a multicast router of the IP sub-network where the host is located by sending a “membership reporting” message. An IP module of the host makes corresponding preparation to receive data transmitted from the multicast group. If the host is the first one joining in the multicast group in the IP sub-network where the host is located, the multicast router is added to a multicast tree through route information exchanging.

After a host joining in a multicast group, a network interface card of the host of the receiver begins to intercept multicast Media Access Control (MAC) addresses relating to the address of the multicast group. A multicast router sends an information packet of a sender to a network section having a receiver hop by hop. A multicast router in a Local Area Network (LAN) transforms a group address carried in the information packet into a MAC address relating to the group address. A receiver intercepts this address, and after receiving the information packet, obtains the multicast data packet of the IP layer and transmits the multicast data packet to an upper layer.

In general, one of the following two methods is adopted when a host exits a multicast group.

1. A host will quit by itself when leaving a multicast group and the multicast router queries the group addresses (224.0.0.1) of all the hosts of an IP sub-network using a “member qualification query” periodically. The multicast router will not forward the data of a multicast group in an IP sub-network if the multicast router has confirmed there is no member of the multicast group in the sub-network. At the same time, the multicast router will be deleted from the specific multicast group distribution tree through route information exchanging. In such a method, there is a time delay for a multicast router confirming there is no member of a multicast group in an IP sub-network. Delay of a certain time in this method will be brought on no matter a user terminal quits normally or becomes power off abnormally.

2. When leaving a multicast group, a host notifies a multicast router in a sub-network initiatively. Then the multicast router queries all the multicast groups in the IP sub-network at once and stops forwarding for a specific multicast group if there is no response. By adopting such a method, the multicast can be stopped in a real-time manner. However, in the case that a user terminal becomes power off abnormally, the multicast router cannot initiate the query procedure because the host cannot notify the multicast router initiatively. Therefore, in this method, the problem caused by abnormally becoming power off of a user terminal cannot be solved.

Besides the two methods above, a multicast router also supports a multicast group membership query function, to query about members in a group. The multicast group member query function includes a general group query and a specific group query. The general group query is to query about members of all the groups, no matter which group the queried member belongs to. The specific group query is to query about the members of a specific group.

After a user terminal becomes power off abnormally, a multicast router can stop forwarding the multicast data after confirming there is no member in the multicast group using the query method above. However, there is a problem that the query is not in a real-time manner because there is a certain interval in such a query.

In an Internet Protocol Television (IPTV) service, each channel is carried by one multicast group in general. When a user wants to watch a certain channel, the user terminal will send an IGMP Join message. Upon receiving the IGMP Join message, network equipment adds the user to a corresponding multicast group and forwards messages of the multicast group to the user. If the user switches the channel, the user terminal will send an IGMP Leave message to leave the channel mentioned above and send another IGMP Join message to join a new channel. Upon receiving the IGMP Leave message, the network equipment sends a specific group query message. If no response is received, which denotes that there is no other users watching the program of the channel, the network equipment stops forwarding data of the multicast group and deletes the user in the multicast group. Upon receiving the IGMP Join message, the network equipment adds the user to a new multicast group and forwards the messages of the multicast group to the user.

A description is hereinafter given by taking a Digital Subscriber Line (DSL) of a Digital Subscriber Line Access Multiplexer (DSLAM) as an example.

When a user switches a TV channel, the user terminal sends an IGMP Leave message to leave a channel (corresponding to a multicast group) and then sends an IGMP Join message to join a new channel (corresponding to another multicast group). In general, when a user stops watching TV and turns off the user terminal, the user terminal sends an IGMP Leave message to leave the channel which the user watches. Upon receiving the IGMP Leave message, the DSLAM stops forwarding data flow of the multicast group of the channel.

However, as shown in FIG. 1, the user terminal will not send an IGMP Leave message when becoming power off abnormally. The DSLAM will keep forwarding the data flow of the multicast group of the channel to the user because no IGMP Leave message of the user terminal is received. When being electrified and starting up again, the user terminal may send an IGMP Join message to join another channel. Thus, to the DSLAM, the user watches two channels simultaneously, resulting in that the DSLAM simultaneously forwards contents of the new channel and the old channel to the DSL port. There are the following problems in such a processing method.

Bandwidth is wasted and bandwidths of other services are occupied, which may result in that other services, such as a data service (accessing the network), have not enough bandwidth. In an even worse case, traffic may exceed the line bandwidth of the DSL, resulting in that packet loss occurs and thereby any of the channels cannot be watched.

### SUMMARY OF THE INVENTION

A method and system for processing abnormally becoming power off of a terminal of multicast user are provided, so as to solve the problem that when becoming power off abnormally and starting up again, terminal of a multicast user notifies multicast device to delete the multicast group in which the user terminal joined before becoming power off.

Embodiments of the present invention adopt the following technical solutions.

A method for processing abnormally becoming power off of a multicast user terminal, includes:

deleting, by a multicast device, multicast group(s) corresponding to the multicast user terminal and not watched by any multicast user terminal, upon receipt of a notification from the multicast user terminal for exiting all multicast groups when the multicast user terminal becomes powered off and started up again.

A system for processing abnormally becoming power off of a multicast user terminal, includes:

the multicast user terminal, for notifying a multicast device that the multicast user terminal requests to exit all multicast groups when being powered off abnormally and started up again;

the multicast device, for deleting the multicast group(s) corresponding to the multicast user terminal and not watched by any multicast user terminal when the multicast device is notified by the multicast user terminal for exiting all multicast groups.

Embodiments of the present invention overcome disadvantage of the prior art, specifically, with a technical solution, in which a user terminal sends a global leave message to a multicast device when becoming power off abnormally and starting up again, the multicast device deletes a multicast group which is not watched by a user according to the message. A problem that the multicast device keeps forwarding the data flow of the multicast group in which the user terminal joined before becoming power off to the user terminal, when the user terminal becomes power off and starts up again is solved. The problem above is solved based on existing processing mechanism of the multicast protocol and the standard IGMP, thereby bandwidth of a line can be saved effectively, which enables bandwidths of other services to be guaranteed better.

### BRIEF DESCRIPTION OF THE DRAWINGS

FIG. 1 shows a flow chart of the processing when a user terminal becomes power off and starts up again in the prior art.

FIG. 2 shows a flow chart of a first embodiment of the present invention.

FIG. 3 shows a flow chart of a second embodiment of the present invention.

FIG. 4 shows a flow chart of a third embodiment of the present invention.

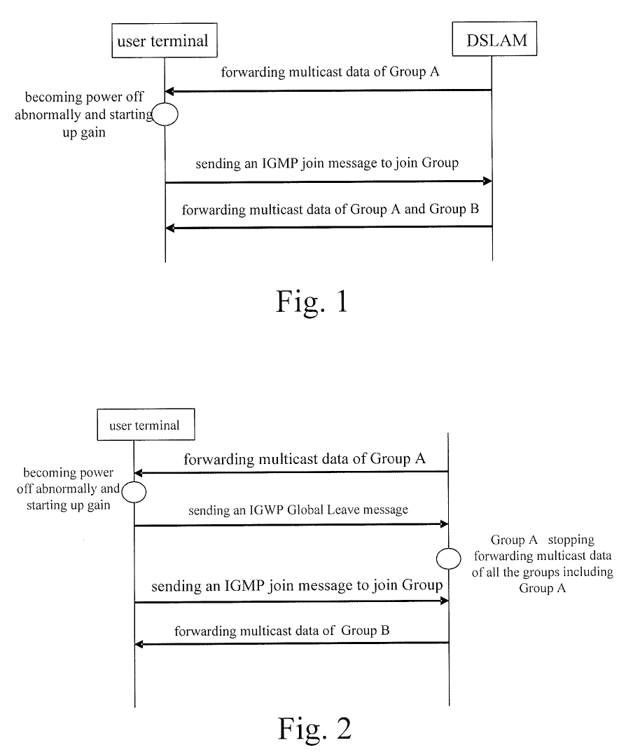

### EMBODIMENTS OF THE INVENTION

Embodiments of the present invention adopt a technical solution, in which a user terminal sends an IGMP Global Leave message to a multicast device when becoming power off and starting up again. Upon receiving the IGMP Global Leave message, the multicast device first deletes a multicast group which is not watched by a terminal in the user port corresponding to the user terminal, then adds the user terminal to a multicast group corresponding to a channel which the user terminal wants to watch according to an IGMP Join message sent by the user terminal.

Detailed descriptions are hereinafter given by taking a DSLAM and an STB as examples.

When becoming power off and starting up again, a user terminal, i.e, an STB, first sends an IGMP Global Leave message, in which a group address is 0.0.0.0 and denoting that the IGMP Leave message is a global leave message used for the user terminal leaving all the multicast groups.

There are three processing methods after the DSLAM receiving the IGMP Global Leave message from the user port.

1) Delete the user in all the multicast groups.

2) Send a specific group query message to determine whether an existing multicast group in the port is watched by a terminal, time and interval of sending the specific group query message are configurable.

3) Send a general group query message to find out a multicast group in which there is no member, time and interval of sending the general group query message are configurable.

A first Embodiment: the flow chart corresponding to the first processing method above is shown in FIG. 2.

1. The user terminal is watching a program of group A before the user terminal becomes power off.

2. When becoming power off and starting up again, the user terminal sends an IGMP Global Leave message to notify the DSLAM of the request of the user terminal for leaving all the multicast groups.

3. Upon receiving the IGMP Global Leave message, the DSLAM deletes all the multicast groups which the user port corresponding to the user terminal has joined and stops forwarding messages of group A at the same time.

4. The user terminal sends an IGMP Join message to join group B.

5. The DSLAM forwards data flows of group B to the user port and the user terminal can watch a program of group B normally.

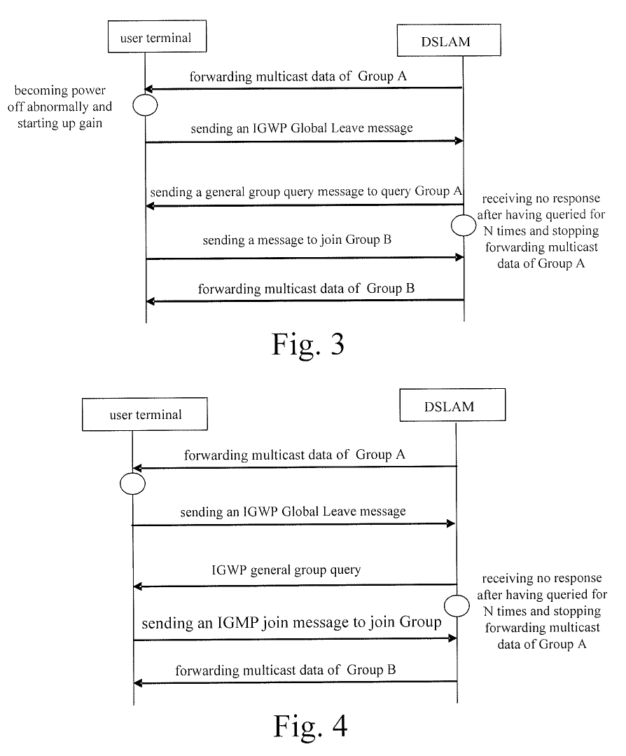

A second Embodiment: the flow chart corresponding to the second processing method above is shown in FIG. 3.

1. The user terminal is watching a program of group A before the user terminal becomes power off.

2. When becoming power off and starting up again, the user terminal sends an IGMP Global Leave message to notify the DSLAM of the request of the user terminal for leaving all the multicast groups.

3. Upon receiving the IGMP Global Leave message, the DSLAM sends a specific group query message, i.e., an IGMP Query of A (if the DSLAM records that there is another multicast group being watched in the user port, a specific group query message will be sent for the multicast group), to query whether there is a user terminal watching program of group A in the user port.

4. If no user terminal is watching programs in the home network and the DSLAM does not receive a query response for N times, the DSLAM deletes all the multicast groups which the user has joined. If another user terminal, i.e., user terminal B, is watching program of group A, user terminal B will send a query response message to notify the DSLAM that a user is watching program of group A and the DSLAM will reserve group A and delete other multicast groups which the user has joined.

5. The user terminal sends an IGMP Join message to join group B.

6. The DSLAM forwards data flows of group B to the user port and then the user terminal can watch a program of group B normally.

A third Embodiment: the flow chart corresponding to the third processing method above is shown in FIG. 4.

1. The user terminal is watching a program of group A before the user terminal becomes power off.

2. When becoming power off and starting up again, the user terminal sends an IGMP Global Leave message.

3. Upon receiving the IGMP Global Leave message, the DSLAM sends a general group query message, i.e., an IGMP General Query message, to query whether there are other user terminals watching the multicast program in the user port.

4. If no other user terminal is watching the program in the user port and the DSLAM does not receive a query response for N times, the DSLAM will delete all the multicast groups which the user has joined. If there is another user terminal, i.e., user terminal B, is watching program of group C, user terminal B will send a query response message to notify the DSLAM that a user is watching the program of group C and the DSLAM will reserve group C and delete other multicast groups which the user has joined.

5. The user terminal sends an IGMP Join message to join group B.

6. The DSLAM forwards data flows of group B to the user port and the user terminal can watch a program of group B normally.

1. A method for processing abnormally becoming power off of a multicast user terminal, comprising:
deleting, by a multicast device, multicast group(s) corresponding to the multicast user terminal and not watched by any multicast user terminal, upon receipt of a notification from the multicast user terminal for exiting all multicast groups when the multicast user terminal becomes powered off and started up again.

2. The method of claim 1, wherein the notification from the multicast user terminal for exiting all multicast groups is a Global Leave message.

3. The method of claim 1, wherein the multicast device deletes the multicast group(s) which is(are) not watched by any multicast user terminal in a user port corresponding to the multicast user terminal.

4. The method of claim 2, wherein a group address in the Global Leave message is 0.0.0.0, which is used for denoting a request of the multicast user terminal for leaving all multicast groups.

5. The method of claim 1, wherein the process of deleting the multicast group(s) corresponding to the multicast user terminal and not watched by any multicast user terminal comprises:
sending a general group query message to a user port corresponding to the multicast user terminal to query whether there is a multicast user terminal receiving a multicast data flow in the user port corresponding to the multicast user terminal;
deleting the multicast group(s) in the user port corresponding to the multicast user terminal if receiving no query response;
reserving the multicast group which is still watched by a multicast user terminal in the user port, and deleting the multicast group which is not watched by any multicast user terminal in the user port if receiving an query response.

6. The method of claim 1, wherein the process of deleting the multicast group(s) corresponding to the multicast user terminal and not watched by any multicast user terminal comprises:
sending a specific group query message to a user port corresponding to the multicast user terminal to query whether there is a multicast user terminal receiving a multicast data flow in the user port corresponding to the multicast user terminal;
deleting the multicast group in the user port if receiving no query response;
reserving the multicast group which is still watched by a multicast user terminal in the user port and deleting the multicast group which is not watched by any multicast user terminal in the user port if receiving an query response.

7. The method of claim 5, wherein the general group query message is sent for preset times.

8. The method of claim 6, wherein the specific group query message is sent for preset times.

9. The method of claim 1, after the multicast device deleting the multicast group(s) which is(are) not watched by any multicast user terminal in a user port, the method further comprising:
sending, by the multicast user terminal, a multicast group join message to the multicast device after being powered off and started up again; and
forwarding, by the multicast device, a multicast data flow to the user port corresponding to the multicast user terminal.

10. A system for processing abnormally becoming power off of a multicast user terminal, comprising:
the multicast user terminal, for notifying a multicast device that the multicast user terminal requests to exit all multicast groups when being powered off abnormally and started up again;
the multicast device, for deleting the multicast group(s) corresponding to the multicast user terminal and not watched by any multicast user terminal when the multicast device is notified by the multicast user terminal for exiting all multicast groups.

11. The system of claim 10, wherein the multicast user terminal notifies the multicast device that the multicast user terminal requests to exit all multicast groups by sending a Global Leave message.

12. The system of claim 10, wherein the multicast device deletes the multicast group(s) which is(are) not watched by any multicast user terminal in a user port corresponding to the multicast user terminal.

13. The system of claim 10, wherein the multicast user terminal is a Set-Top Box (STB) while the multicast device is a Digital Subscriber Line Access Multiplexer (DSLAM).
